(19) United States
(12) Patent Application Publication
(10) Pub. No.: US 2003/0026062 A1
(43) Pub. Date: Feb. 6, 2003

(54) Module insertion tool

(76) Inventor: Dong-Hyon Kim, Sunnyvale, CA (US)

Correspondence Address: Brian M. bERLINER, Esq., O'MELVENY & MYERS LLP, 400 South Hope Street, Los Angeles,, CA, 90071-2899, US

(21) Appl. No.: 09/924,223

(22) Filed: Aug. 6, 2001

(51) Int. Cl. H01R 13/62

(52) U.S. Cl. 361/327; 439/327

(57) ABSTRACT

The present invention is a module insertion tool. The module insertion tool has two drivers on either side that operate independently of each other, and help in anchoring the module to a motherboard. There is a knob that is connected to a chain that turns the drivers until a preset torque value is reached. Since the two drivers are independent of each other, each driver turns until the preset torque value on its side is reached. This preset torque value can be obtained by either manually turning the knob, or by attaching an electric source to a socket built into the knob. There are three locators on a bottom plate that help in the alignment of the module, and there are locking pins on each driver that hold the module stationary while it is being anchored to the motherboard.

### BACKGROUND OF THE INVENTION

1 Field of the Invention

The present invention relates primarily to the field of hardware, and in particular to a module insertion tool.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

A module has several hardware components connected together in order to create a computer system. Some of the hardware components that need to be connected on a module include a central processing unit (CPU), a static random access memory (SRAM or RAM), and a casing that will connect the module to a motherboard. Usually, most of the hardware components are easy to attach or group together on a module without restriction to their layout. But the module has to be precisely aligned onto the motherboard in order for the computer system to work correctly, and achieving this precise alignment has its own specialized draw-backs which have yet to be overcome.

Incorrect alignment of the module may result in system failure, for example, due to burnt motherboards. An incorrect alignment of the module may result in grounding of a component pin which may cause short circuit in the motherboard when powered. Another outcome of incorrect alignment may result in bent component pins. Yet another outcome may result in cracked fabricators. An incorrect alignment may result in an uneven weight distribution of the module on the motherboard, which may result in cracking of the fabricator.

This loss of material may be extremely costly, especially for a fabrication plant that produces these computer systems in large volumes. If the incorrect alignment of the module does not result in burnt motherboards, bent component pins, or cracked fabricators, to name a few, then there is a loss of man-hours spent in fixing the incorrect alignment of the module since these modules are mounted onto the motherboards with human input. Some of the commercially available desktop modules include the 600/750/900 MHz UltraSPARC-III™ CPU modules made by Sun Microsystems, Inc., where the speed of the CPU is used to categorize the desktop module. One such desktop module, and the present system fabrication problems using this desktop module as an example are discussed in further detail below.

Desktop Module

A desktop module is illustrated in FIG. 1. The desktop module has two drivers 100 shrouded on either side of the module, that are used to anchor the module to a motherboard. These drivers are housed in connectors 110 also called captive screws. A surface mount matched impedance connector, or MICTOR, is one such connector used to anchor the module to a motherboard. The present design of the desktop module, and the attached drivers in the connectors require a precise quarter turn to each of the pre-set torque drivers in succession to ensure the module is inserted on the motherboard as parallel as possible.

The requirement of having the desktop module precisely parallel to the motherboard is critical in ensuring that each pin of every component on the module has mated correctly with its counterpart on the motherboard. Since the requirement of having the desktop module precisely parallel is performed by a human operator, it can be a time consuming task to accomplish, especially since many desktop module are bulky and heavy. Even if the desktop module is mounted on the motherboard with utmost care, it may still result in a low accuracy of the installation because currently there are no mechanical tools to help in aligning the module perfectly parallel to the motherboard. Parallelism is eyeballed by a human operator.

Furthermore, since the task of aligning the desktop module parallel to the motherboard is done manually, there can be a faulty installation of the desktop module resulting in bent component pins, cracked fabricators, burnt modules, connectors, and motherboards. Moreover, there may be several different groups of human operators that mount one or more desktop modules on a motherboard (some system designs warrant multiple modules per motherboard), or group other components together at the system level. There may be some individuals in the group that do not follow the stringent requirement of alternately turning each of the drivers in the connectors by a precise quarter turn, or there may be other time constraints like deadlines that result in faulty and incorrect mounting of the desktop module onto the motherboard. These are some of the reasons that eventually result in an unrecoverable loss of both man-hours and material.

### SUMMARY OF THE INVENTION

The present invention is a module insertion tool. According to one embodiment of the present invention, the module is a desktop module. According to another embodiment of the present invention, there are two drivers on either side of the module insertion tool that operate independently of each other. According to another embodiment of the present invention, these drivers are used to anchor the module to a motherboard. According to another embodiment of the present invention, each driver has a slip coupling disk connected by a chain that ends in a plastic knob. By rotating the plastic knob, both the drivers independently turn in the direction of the rotation.

According to another embodiment of the present invention, there is a preset torque on the drivers, which are user dependent. In other words, the torque value has to be inputted manually, but can be changed for different situations and designs of the module and motherboard. According to another embodiment of the present invention, the drivers will turn until the preset torque value on the drivers is met. Since the drivers are independent of each other, each driver will stop turning when the preset torque value on its end is reached.

According to another embodiment of the present invention, there are three locators on a bottom plate of the module insertion tool that help in the alignment of the module. According to another embodiment of the present invention, there is a locking pin on each of the two drivers that help in securing the module to the motherboard. According to another embodiment of the present invention, a gear holder helps in controlling the tension in the chain. According to another embodiment of the present invention, a socket attached to the knob allows a user to connect an electrically powered driver. This driver aids in accelerating the process time needed to mount the module onto the motherboard.

### BRIEF DESCRIPTION OF THE DRAWINGS

These and other features, aspects and advantages of the present invention will become better understood with regard to the following description, appended claims and accompanying drawings where:

FIG. 1 is an illustration of a prior art module.

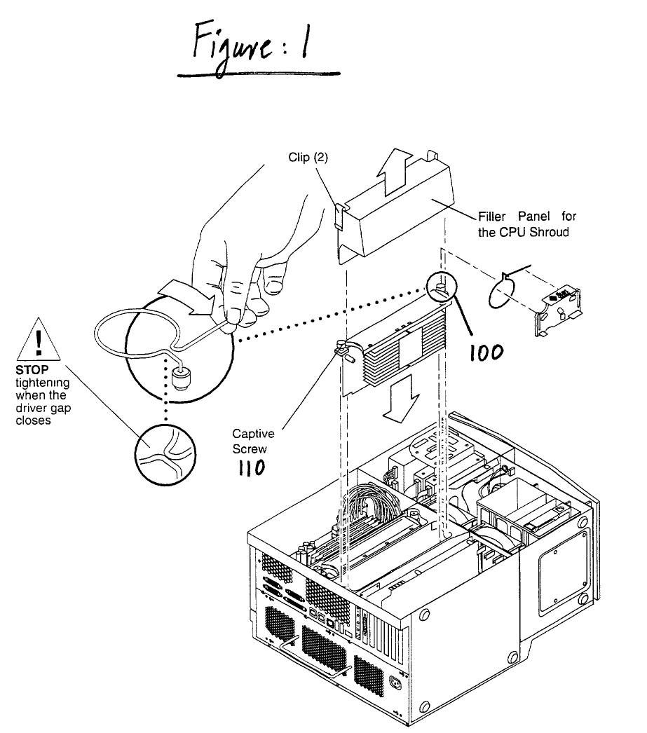

FIG. 2 is a cross-sectional view of the present invention.

FIG. 3 illustrates one or more embodiments of the present invention.

FIG. 4 illustrates one or more embodiments of the present invention.

FIG. 5 illustrates one or more embodiments of the present invention.

FIG. 6 illustrates one or more embodiments of the present invention.

FIG. 7 illustrates one or more embodiments of the present invention.

FIG. 8 illustrates one or more embodiments of the present invention.

### DETAILED DESCRIPTION OF THE INVENTION

The invention is a module insertion tool. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Desktop Module

According to one embodiment of the present invention, the module is a desktop module. The UltraSPARC-III™ CPU desktop module is one example of a desktop module that will be used to disclose the design and usefulness of the present invention. But the present invention can be used on other modules, and is not restricted to the UltraSPARC-III™ CPU desktop module. Furthermore, the illustrations of the module insertion tool have dimensions in inches, and specifications of materials made out of steel, aluminum, etc., which are for illustration purposes only. The scope of the present invention is not restricted to the dimensions or to the material specifications mentioned in the illustrations, and can be implemented using other dimensions and materials which will be dictated by the design and shape of the module and motherboard.

Module Insertion Tool

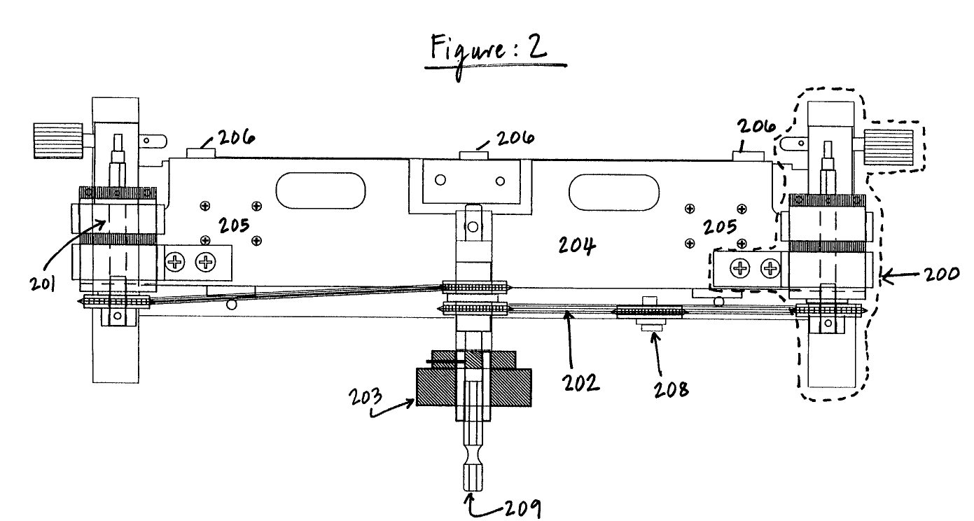

A cross-sectional view of the present invention is illustrated in FIG. 2, where 200 are two drivers on either side of the module insertion tool. Each driver has a slip coupling disk 201 connected by a chain 202 that ends in a knob 203. Knob 203 may be made out of plastic or similar material. There are two plates in the module insertion tool, where 204 is the top plate and 205 is the bottom plate. 206 indicates 3 locators on the bottom plate, and 207 indicates locking pins on both sides of the module insertion tool. 208 indicates a gear holder that helps in controlling the tension in chain 202. Socket 209, which allows a user to electrically power the driver, is built into knob 203. Each of these parts along with their functionality and usage are explained in further detail below.

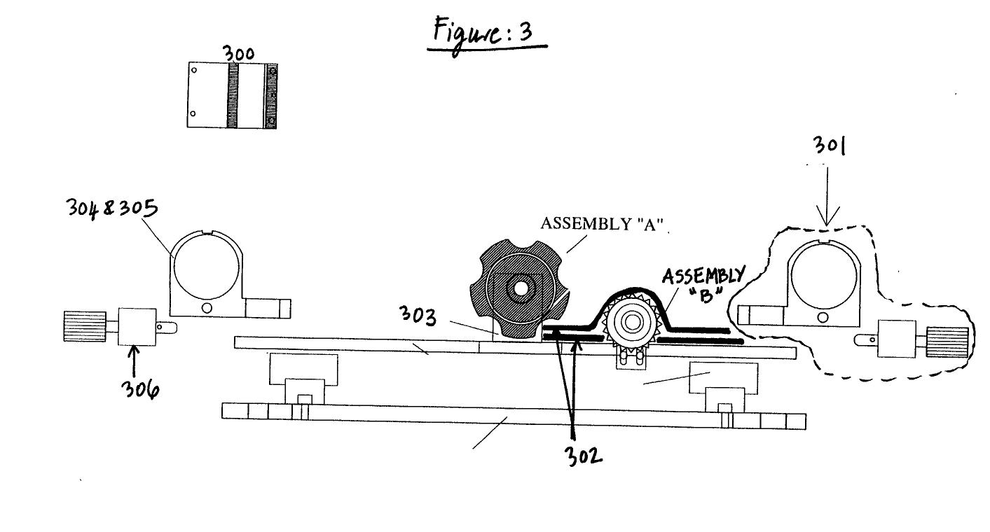

FIG. 3 illustrates one or more embodiments of the present invention. The figure shows a detailed illustration of the two drivers, slip coupling disk, knob, chain, and locking pins. Slip coupling disk 300 ensures that drivers 301 do not slip when chain 302 is tightened or loosened by rotating knob 303. The slip coupling is encased in coupling holders 304 and 305. Locking pins 306, which can be rotated clockwise to lock the insertion tool in a desired position, and anti-clockwise to unlock the module insertion tool, help in keeping the drivers stationary during the entire operation of mounting the module to a motherboard.

The drivers have a preset torque, which is inputted by a user depending upon the design requirements of the module and motherboard. In operation, once the module is placed in position, the locking pins are tightened to ensure that the module remains stationary during the entire operation. Next, the knob is turned either clockwise or anti-clockwise. This moves the chain, which increases or decreases the torque in the drivers. Since the drivers are independent of each other, each driver turns until the preset torque on its side is met. In other words, one driver may reach its preset torque value sooner than the other, but each driver will stop independent of the other once its preset torque value has been reached. This ensures that even if the module was not perfectly parallel to the motherboard at the beginning of the operation, it will be once both the drivers stop turning.

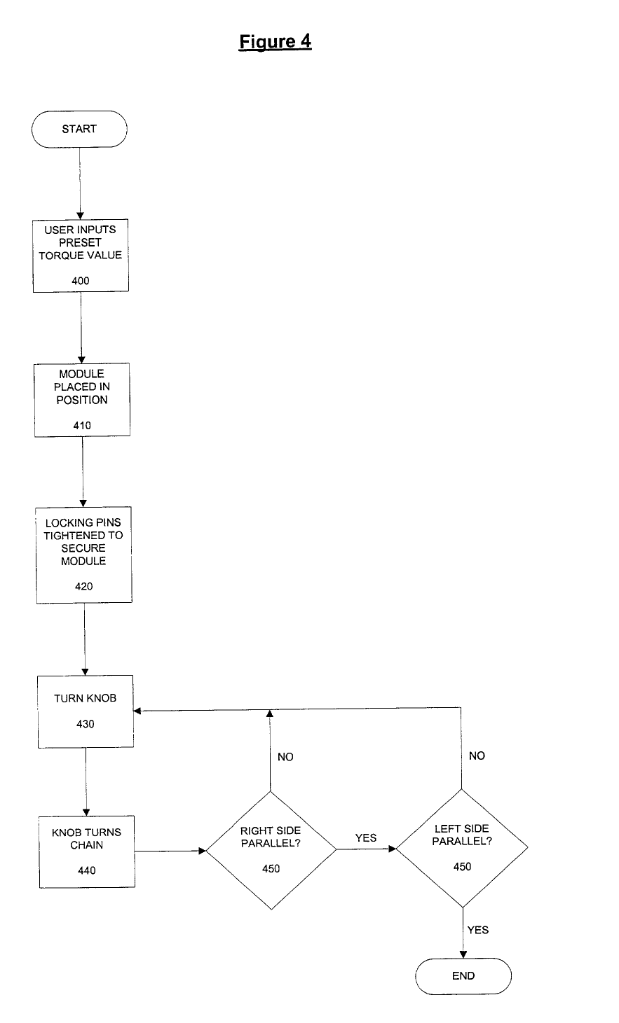

FIG. 4 illustrates the operation of manually attaching a module parallel to a motherboard. At box 400, a user inputs a preset torque value. At box 410, a module is placed in position over a motherboard. At box 420, locking pins on the module are tightened to secure the module from moving. At box 430, a knob on the module is turned. This knob turns a chain, which is seen at box 440. At box 450, a check is made to see if the right side of the module has reached the preset torque value. If it has not, then boxes 430 and 440 are repeated until the preset torque value on the right side of the module is reached. Once the right side is level, at box 460 a check is made to see if the left side of the module has reached the preset torque value. If it has not, then boxes 430 through 450 are repeated until the preset torque value on the left side of the module is reached. It must be noted here that boxes 450 and 460 can be interchanged. In other words, the left side can be checked for parallelism before the right side.

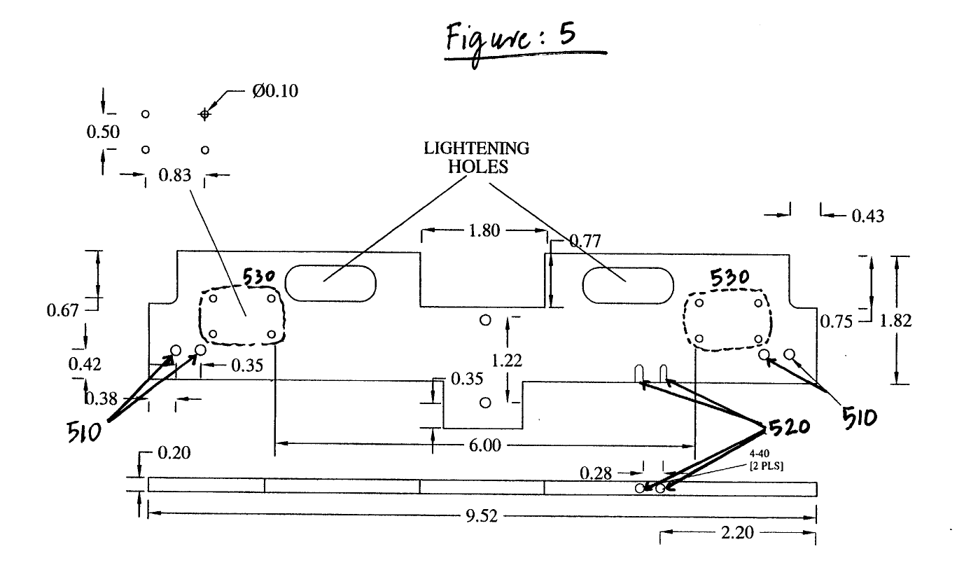

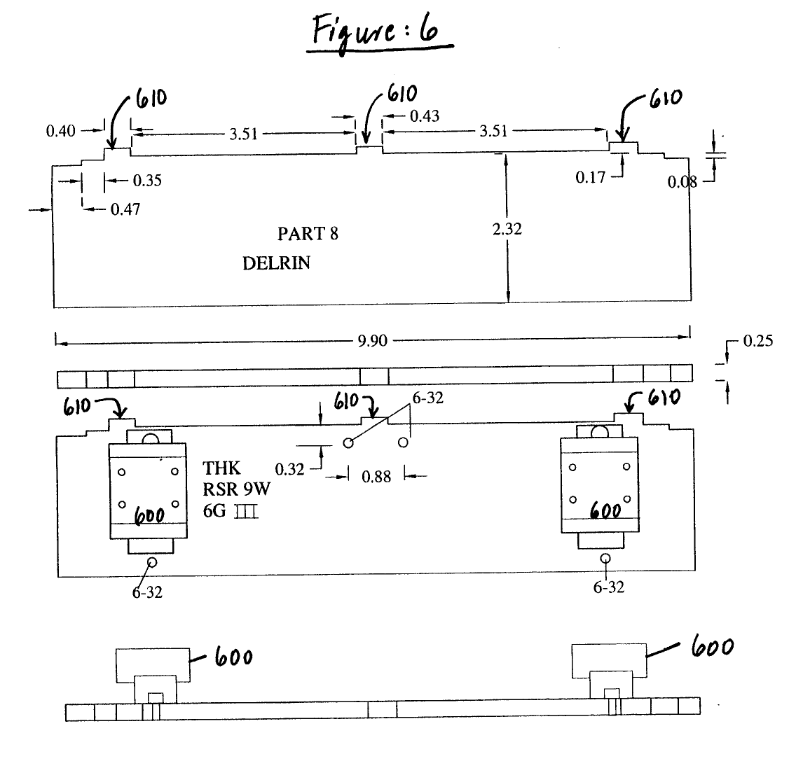

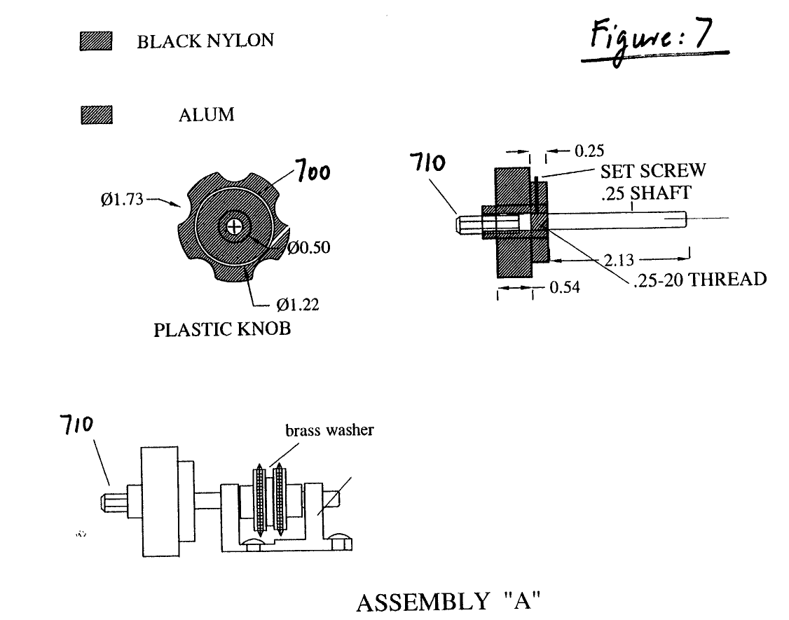

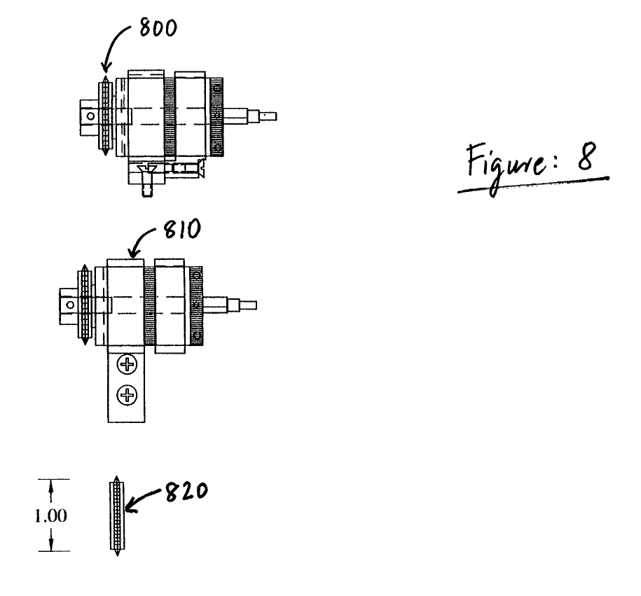

Top plate 204 is explained in detail in FIG. 5, bottom plate 205 is explained in detail in FIG. 6, knob assembly “A” is explained in detail in FIG. 7, and gear holder assembly “B” is explained in detail in FIG. 8.

Top Plate

FIG. 5 illustrates one or more embodiments of the present invention. The figure shows a side and top view of the top plate. It has two openings (500) called lightening holes, which are made to reduce the overall weight of the module, and two holes (510) on either side where the driver assemblies get attached. It also has a couple of holes (520) where the gear holder parts get attached. The top and bottom plates are held in place with the help of two rectangular pieces, and the top plate has a set of 4 screw holes (530) on either side where these rectangular pieces get attached.

Bottom Plate

FIG. 6 illustrates one or more embodiments of the present invention. The figure shows one side view, and two top views of the bottom plate. One of the top view illustration also shows the two rectangular pieces 600 that hold the top and bottom plates in place. 610 indicates three locators on the bottom plate that help in aligning the indentations on the module with the motherboard.

Knob Assembly “A”

FIG. 7 illustrates one or more embodiments of the present invention. One view shows an illustration of plastic knob 700 along with its dimensions. Another is a side view of standard socket 710, which is built directly into the knob. This socket is used to connect an electrical source if the chain's torque is adjusted by non-manual means. The last illustration is a detailed view of socket 710 built into knob 700.

Gear Holder Assembly “B”

FIG. 8 illustrates one or more embodiments of the present invention. The figure shows two top views (800 and 810) of the gear holder assembly. This assembly is attached to the bottom plate and has a toothed wheel 820 around which a chain is wrapped. The other two side view figures are of parts that hold the toothed wheel 820 in place. This toothed wheel pushes up on the chain, and this controls the tension in the chain while the torque value is being manipulated by turning the knob.

Thus, a module insertion tool is described in conjunction with one or more specific embodiments. The invention is defined by the following claims and their full scope of equivalents.

We claim:

1. A module insertion tool comprising:
one or more drivers built into said module insertion tool to anchor a module to a motherboard;
one or more locators built into said module insertion tool to align said module to said motherboard; and
an electric source configured to be connected to a socket built into said module insertion tool.

2. The module insertion tool of claim 1 wherein said module is a desktop module.

3. The module insertion tool of claim 1 wherein said one or more drivers function independent of each other.

4. The module insertion tool of claim 3 wherein said one or more drivers comprise a slip coupling disk.

5. The module insertion tool of claim 4 wherein said slip coupling disk is connected by a chain, wherein said chain ends in a knob that houses said socket.

6. The module insertion tool of claim 5 wherein said knob turns said chain, which rotates said one or more drivers.

7. The module insertion tool of claim 6 wherein said chain turns around a gear holder, wherein said gear holder controls the tension in said chain.

8. The module insertion tool of claim 1 wherein said one or more drivers have a preset torque, wherein said torque is user dependent.

9. The module insertion tool of claim 8 wherein said one or more drivers rotate independently of each other until said preset torque on its side is met.

10. The module insertion tool of claim 1 wherein said one or more drivers have locking pins, wherein said locking pins anchor said module to said motherboard.

11. A method for implementing a module insertion tool comprising:
building one or more drivers into said module insertion tool to anchor a module to a motherboard;
building one or more locators into said module insertion tool to align said module to said motherboard; and
configuring an electric source connected to a socket built into said module insertion tool.

12. The method of claim 11 wherein said module is a desktop module.

13. The method of claim 11 wherein said one or more drivers function independent of each other.

14. The method of claim 13 wherein said one or more drivers comprise a slip coupling disk.

15. The method of claim 14 wherein said one or more drivers comprise a slip coupling disk.

16. The method of claim 15 wherein said knob turns said chain, which rotates said one or more drivers.

17. The method of claim 16 wherein said chain turns around a gear holder, wherein said gear holder controls the tension in said chain.

18. The method of claim 11 wherein said one or more drivers have a preset torque, wherein said torque is user dependent.

19. The method of claim 18 wherein said one or more drivers rotate independently of each other until said preset torque on its side is met.

20. The method of claim 11 wherein said one or more drivers have locking pins, wherein said locking pins anchor said module to said motherboard.
